(19) United States
(12) Patent Application Publication
(10) Pub. No.: US 2011/0078465 A1
(43) Pub. Date: Mar. 31, 2011

(54) INFORMATION PROCESSING APPARATUS, METHOD OF CONTROLLING INFORMATION PROCESSING APPARATUS, AND STORAGE MEDIUM

(75) Inventor: Yoshiharu Ito, Kawasaki-shi (JP)

(73) Assignee: CANON KABUSHIKI KAISHA, Tokyo (JP)

(21) Appl. No.: 12/886,333

(22) Filed: Sep. 20, 2010

(30) Foreign Application Priority Data
Sep. 25, 2009 (JP) 2009-221340

(51) Int. Cl. G06F 1/00

(52) U.S. Cl. 713/300

(57) ABSTRACT

When a control unit is in a power saving mode, if a job is received from a host apparatus, a NIC unit responds by proxy to the job by using only some of devices in the control unit. In a case where it is determined that the NIC unit cannot respond by proxy to the job, it is determined based on a packet pattern of the job whether the job can be dealt with using only some of devices disposed in the control unit. If it is determined that the job can be dealt with using only some of devices, the NIC unit deals with the job using some of devices.

### BACKGROUND OF THE INVENTION

1. Field of the Invention

The present invention relates to an image forming apparatus configured to process a job received from a host apparatus.

2. Description of the Related Art

Some network devices for network communication have a function of saving power consumption by automatically switching into a power saving state when no operation is performed over a predetermined period.

In such a network device, when it is in a power saving state, if it is operated by another device via a network, the network device returns to a normal state from the power saving state.

In a method, returning to the normal state from the power saving state is performed such that when an input signal is received via a network, a pattern of the received input signal is compared with an input signal pattern registered in advance. If the pattern of the received input signal is identical to the registered input signal pattern, the network device returns to the normal state from the power saving state.

It is known to use an input signal pattern called a Magic Packet™, which is a special pattern that does not appear in normal communication, to return a network device from a power saving state into a normal power state (see, for example, Japanese Patent Laid-Open No. 2006-270538). The input signal pattern used here refers to a packet pattern used in Ethernet™. However, not only Ethernet packet patterns but general input signal patterns can be used in the present invention. Therefore, hereinafter, those patterns will be generically referred to as input signal patterns.

In the network device having the power saving function, a known signal pattern such as a MAC address of the network device is assigned in advance as the input signal pattern used to return the network device from the power saving state into the normal power state, and thus anybody who knows the assigned input signal pattern can awake the network device from the power saving state.

This can cause the network device to exit the power saving state when the network device should remain in the power saving state. That is, the network device cannot remain in the power saving state over a period during which it should remain in the power saving state.

In the technique disclosed in Japanese Patent Laid-Open No. 2006-270538, the determination as to whether the network device should exit the power saving state is made simply based on a comparison of a particular bit pattern, and nothing is taken into consideration as to switching into one of a plurality of power saving states. The network device is fully activated into the normal power state in response to even a simple inquiry that can be dealt with out fully activating the network device. For example, even when the inquiry does not request a printing operation, power activation is performed for the whole network device including parts associated with the printing operation. This also makes it difficult to maintain the power saving state for a long period.

### SUMMARY OF THE INVENTION

In view of the above, the present invention provides a technique of controlling the power state such that when a control unit is in a power saving mode, if a job is received from a host apparatus, a NIC unit responds by proxy to the job by using only some particular one or more of devices in the control unit.

More specifically, the present invention provides an information processing apparatus comprising a processing unit configured to process data and a storage unit configured to store data, the information processing apparatus being operable in one of power states including a first power state in which the processing unit can process data and can read data from the storage unit, a second power state in which the processing unit cannot process data but the processing unit can read data from the storage unit, and a third power state in which the processing unit cannot process data and the processing unit cannot read data from the storage unit, the information processing apparatus further comprising a receiving unit configured to receive data, and a control unit configured to control the power state of the information processing apparatus such that in a case where the receiving unit receives data when the information processing apparatus is operating in the third power state, the power state of the information processing apparatus is controlled as follows: in a case where the data received by the receiving unit does not need a process by the processing unit but data stored in the storage unit is necessary in processing the data received by the receiving unit, the power state of the information processing apparatus is switched from the third power state into the second power state; and in a case where the data received by the receiving unit does not need a process by the processing unit and data stored in the storage unit is not necessary in processing the data received by the receiving unit, the power state of the information processing apparatus is maintained in the third power state.

Further features of the present invention will become apparent from the following description of exemplary embodiments with reference to the attached drawings.

### BRIEF DESCRIPTION OF THE DRAWINGS

FIG. 1 is a block diagram schematically illustrating a configuration of an image input/output system.

FIG. 2 is a diagram illustrating a configuration of an image forming apparatus.

FIG. 3A is a diagram illustrating an example of a configuration of a power supply unit in an image forming apparatus, and FIG. 3B is a diagram illustrating another example of a configuration of the power supply unit.

FIG. 4 is a diagram illustrating a configuration of a power supply control unit according to an embodiment of the invention.

FIG. 5 is a table of power states of a power supply circuit.

FIG. 6 is a flow chart illustrating a power control process performed in an image forming apparatus.

FIG. 7 is a flow chart illustrating a power control process performed in an image forming apparatus.

FIG. 8 is a pattern table managed by an image forming apparatus.

FIG. 9 is a flow chart illustrating a power control process performed in an image forming apparatus.

FIG. 10 is a flow chart illustrating a power control process performed in an image forming apparatus.

### DESCRIPTION OF THE EMBODIMENTS

The present invention is described in further detail below with reference to embodiments in conjunction with the accompanying drawings.

### First Embodiment

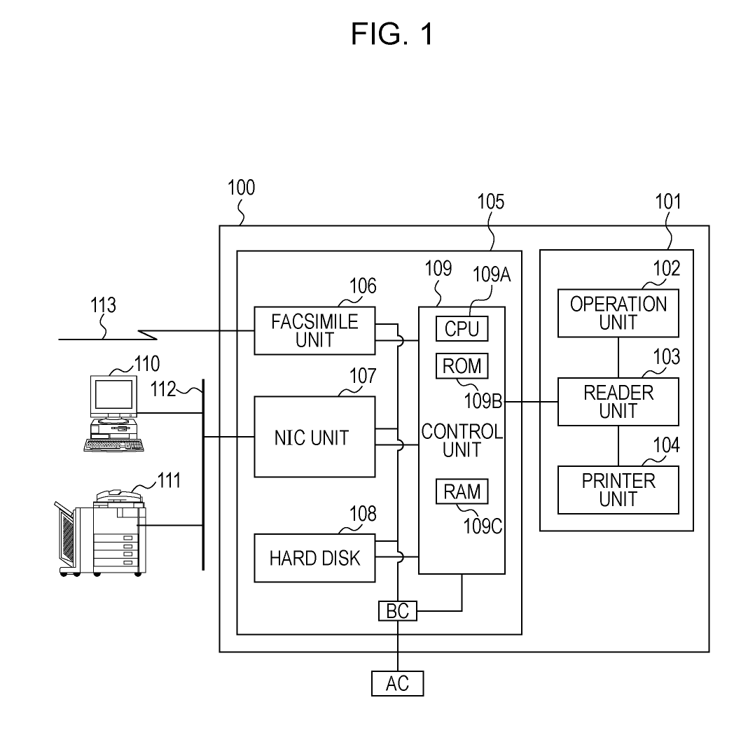

FIG. 1 is a block diagram illustrating a configuration of an image input/output system according to an embodiment of the present invention. In the example shown in FIG. 1, the image input/output system includes an image forming apparatus. Although in this example the image forming apparatus is employed as an information processing apparatus, the information processing apparatus may be another apparatus or system configured to process data.

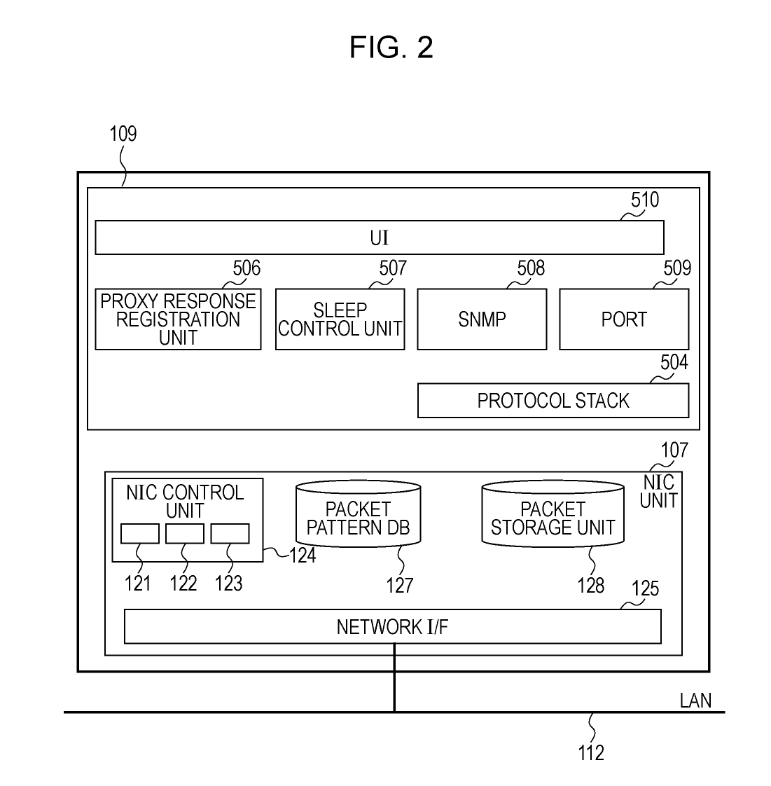

FIG. 2 is a diagram illustrating hardware and software configurations of the image forming apparatus 100 shown in FIG. 1. In this specific example shown in FIG. 2, the image forming apparatus in the image input/output system is assumed to be an MFP (Multi Function Peripheral) configured to communicate, using a particular protocol, with a network device via a network. In the image input/output system, the image forming apparatuses 100 and 111 are capable of communicating with an information processing apparatus (host apparatus) 110 via a network such as a LAN (Local Area Network) 112. As for the host apparatus 110, a personal computer (PC) or a workstation may be used. The host apparatus 110 has a printer driver and other utility software installed therein whereby communication with the image forming apparatus 100 or 111 is allowed using the printer driver and information associated with the image forming apparatus 100 or 111 can be acquired and displayed using the utility software. The host apparatus 110 is configured to communicate with the image forming apparatus 100 using different protocols depending on whether a job is associated with the image forming apparatus 100 or with a communication process.

Depending on the protocol used, the NIC unit 107 responds to a job received from the host apparatus 110 by proxy for the control unit 109 in the power saving mode. For example, if an echo request of ICMP (Internet Control Message Protocol) is received, the NIC unit 107 responds to it. When a job is received from the host apparatus 110, the NIC unit 107 detects the type of the received job to determine whether the NIC unit 107 is to respond to it or the control unit 109 or some of devices in the control unit 109 is to respond to the job. More specifically, as shown in FIG. 2, the NIC unit 107 has a packet pattern database 127 in which packet patterns corresponding to the respective jobs are registered as will be described in detail later.

In the present example, the image input/output system includes two image forming apparatuses. However, there is no particular restriction on the number of image forming apparatuses, as long as there are at least two image forming apparatuses connected to the network. For example, the image input/output system may include three or more image forming apparatuses.

The image forming apparatus 100 and the image forming apparatus 111 are similar in configuration and thus the configuration will be described below only for the image forming apparatus 100 and a description of the configuration of the image forming apparatus 111 will be omitted.

In FIG. 1, the image forming apparatus 100 includes a digital copying unit 101 and an image input/output control unit 105. The digital copying unit 101 is configured to produce image data of an original document by scanning the original document and print an image of the original document on paper according to the image data.

The image input/output control unit 105 is connected to the digital copying unit 101, the network 112, and a telephone line 113, whereby the image input/output control unit 105 controls a process on image data received via the network 112 and the telephone line 113 and transmits resultant image data to the digital copying unit 101 or stores the image data.

The image input/output control unit 105 also controls a process performed on scanned image data transmitted from the digital copying unit 101 and transmits resultant data via the network 112 or the telephone line 113 or stores the data.

The digital copying unit 101 includes an operation unit 102, a reader unit 103 and a printer unit 104 which are connected to each other such that image data and other data can be transmitted among them.

The operation unit 102 is used to issue an operation command to the digital copying unit 101 or the image input/output control unit 105. The reader unit 103 is used to read an image of a document and output image data of the image of the document to the printer unit 104 and the image input/output control unit 105.

The printer unit 104 serving as an image output unit is used to form an image on paper in accordance with image data supplied from the reader unit 103 via the image input/output control unit 105.

The image input/output control unit 105 includes a control unit 109, a facsimile unit 106, a NIC unit 107, and a hard disk 108. The control unit 109 is connected to the reader unit 103 in the digital copying unit 101, and the facsimile unit 106, the NIC unit 107, and the hard disk 108 are connected to the control unit 109. The facsimile unit 106 is connected to the telephone line 113, and the NIC unit 107 is connected to the network 112.

If the facsimile unit 106 receives compressed facsimile data via the telephone line 113, the facsimile unit 106 decompresses the received data and transfers resultant image data to the control unit 109.

When the facsimile unit 106 receives image data from the control unit 109, the facsimile unit 106 compresses the received image data and transmits resultant compressed image data as facsimile data via the telephone line 113. The facsimile unit 106 can temporarily store received compressed image data in the hard disk 108 via the control unit 109.

The NIC unit 107 serves as an interface between the network 112 and the control unit 109, and the NIC unit 107 rasterizes data received from the host apparatus 110 into PDL (Page Description Language) data that is code data indicating an image printable by the printer unit 104, and transmits the resultant PDL data to the control unit 109.

The control unit 109 controls flowing of data, in particular image data, via the reader unit 103, the facsimile unit 106, the NIC unit 107, and the hard disk 108. That is, the control unit 109 controls storing and outputting of image data.

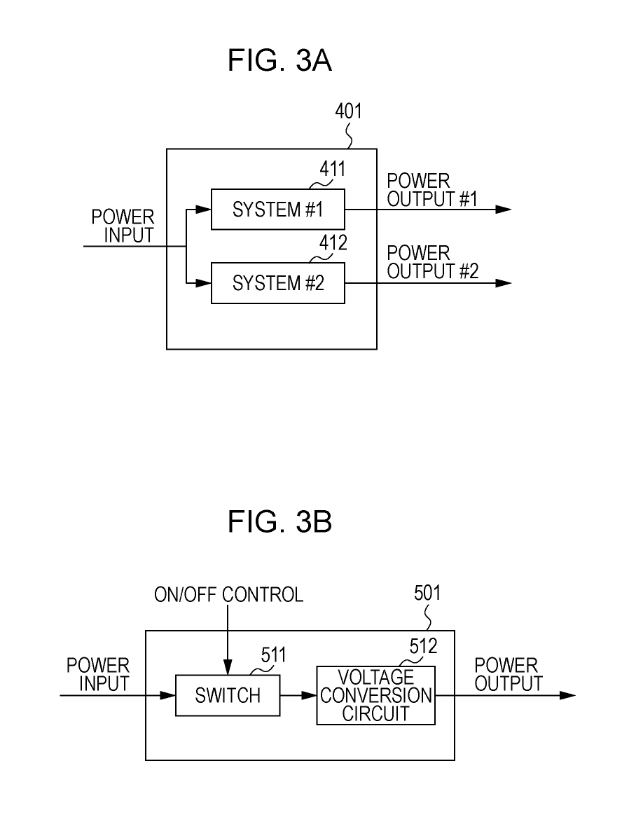

The control unit 109 includes a CPU 109A, a ROM 109B, and a RAM 109C. In a sleep mode (also referred to as a power saving mode), electric power supplied to the control unit 109 from a power supply is cut off. Depending on the type of a packet received by the NIC unit 107, a power supply control unit BC controls the power supply such that electric power is supplied to only some particular one or more of devices such as a nonvolatile memory device serving as the RAM 109C even in the power saving mode. More specifically, the RAM 109C in the control unit 109 is connected to a power supply circuit 501 including a switch 511, which will be described later with reference to FIG. 3B, such that the power supply control unit BC turns on/off the switch 511 under the control of a CPU 121 in the NIC unit 107 to control the electric power to the RAM 109C. Note that, the power supply control unit BC controls electric power such that when electric power to the image forming apparatus 100 is turned on for the first time, the image forming apparatus 100 first operates in a power state #1 (in which electric power is supplied to the whole control unit 109) and then, while the RAM 109C is maintained in this state, the power state is switched into a power state #2 or #3 (in which electric power is supplied to only some particular one or more of devices in the control unit 109). By maintaining the RAM 109C in the state into which the RAM 109C is set when the image forming apparatus 100 is started with the power state #1, it becomes possible to control an operation such that the NIC unit 107 refers to data, status data, flag data, etc., stored in the RAM 109C and responds by proxy to the external host apparatus 110.

The NIC unit 107 includes a controller that controls communication performed via a network and also includes a memory. Note that electric power is supplied to the NIC unit 107 from the power supply control unit BC even in the power saving mode so that the NIC unit 107 can receive a request via the network 112.

Depending on the content of an inquiry received from the host apparatus, the power supply control unit BC determines whether the whole control unit 109 is to be maintained in the power saving state or is to be switched to a particular-level power saving state or completely to a normal power state. The control unit 109 includes a plurality of devices such as a CPU, a ROM, a RAM, a hard disk, etc., and the power supply control unit BC controls supplying of power such that electric power is still supplied to some of devices even after the control unit 109 is switched into the power saving mode.

More specifically, the power supply control unit BC converts AC electric power supplied from an external AC power supply to DC electric power, and supplies the DC electric power to the hard disk 108, the NIC unit 107, the facsimile unit 106, etc. In the sleep mode, the power supply control unit BC switches the power state into the power saving state by turning off electric power to the control unit 109, the hard disk 108, the operation unit 102, the reader unit 103, and the printer unit 104.

In processing a job (which will be described in detail later), the power supply control unit BC determines a packet pattern of a received packet and controls the operation including the proxy response process or a WOL (Wake On LAN) process and reactivation of the control unit 109.

The control described above makes it possible to process a received job without re-activating unnecessary devices even when the received job is not of a type to which the NIC unit 107 is allowed to directly respond by proxy. That is, the received job is dealt with by supplying electric power only to devices necessary in dealing with the job. This allows a reduction in power consumption to execute a job that needs accessing information that is managed by the control unit 109 and that indicates the status of the image forming apparatus, and thus a reduction in total power consumption of the system is achieved.

Referring to FIG. 2, main units of the image forming apparatus 100 are the control unit 109 and the NIC unit 107.

The NIC unit 107 includes a network I/F unit 125 configured to transmit/receive a network packet to/from an external LAN 112, and also includes a NIC control unit 124 configured to activate the NIC unit 107 and communicate with the control unit 109 in the image forming apparatus 100. The NIC unit 107 also includes a packet pattern DB 127 in which proxy response packet patterns are registered such that in accordance with the proxy response packet pattern, the NIC unit 107 responds to the packet received via the LAN 112 by proxy for the control unit 109 in the image forming apparatus 100. The NIC control unit 124 includes a CPU 121, a RAM 123, and a ROM 122.

The control unit 109 includes an SNMP module unit 508 configured to transmit/receive SNMP (Simple Network Management Protocol) to/from an external apparatus (such as the host PC 150) via a network protocol stack 504. The control unit 109 in the image forming apparatus 100 also includes a port module unit 509 configured to perform printing.

The control unit 109 also includes a sleep control unit 507 that controls power saving by switching to/from the sleep mode. The control unit 109 also includes a proxy response registration unit 506 configured to register proxy response packet patterns in the NIC unit 107.

The control unit 109 also includes a user interface (UI) unit 510 used by a user to set functions. The control unit 109 has a function of storing a received packet in a packet storage unit 128.

Next, a description is given below as to a proxy response process performed in the power saving mode by the image forming apparatus configured in the above-described manner.

To achieve the power saving mode, it is common to stop supplying electric power to the CPU of the control unit 109, and only some particular hardware modules are operated during the power saving mode.

To realize the proxy response function in the NIC unit 107, the image forming apparatus has an extension I/F in the NIC unit 107 that makes it possible to communicate with the control unit 109.

Because the NIC unit 107 has the CPU 121, it is possible to receive a job via the network 112 and perform a process associated with it while keeping functions even in the power saving mode in which the control unit 109 and the printer unit 104 do not operate.

The proxy response function refers to a function of responding to a packet by proxy such that in a case where when the control unit 109 is in the power saving mode, a packet addressed to the image forming apparatus 100 is received from the external host PC 110, if the packet has a pattern identical to a registered packet pattern, then the NIC unit 107 or another server responds to this packet by proxy.

The NIC unit 107 in the image forming apparatus is capable of registering an arbitrary number of packet patterns that should be responded to by proxy and corresponding packet patterns that are to be sent in response to the respective received packet patterns. Note that those packet patterns are registering in the network I/F 125 before the operation mode is switched into the power saving mode.

Next, controlling of electric power of the image forming apparatus according to the present embodiment is described.

FIGS. 3A and 3B illustrate examples of configurations for the power supply control unit shown in FIG. 1. FIG. 3A illustrates a conventional configuration of a power supply control unit, while FIG. 3B illustrates a configuration of the power supply unit of the image forming apparatus according to the present embodiment of the invention.

In FIG. 3A, a power supply unit 401 includes power supply circuits 411 and 412 that generate different DC voltages that are supplied via different lines, i.e., the power supply circuits 411 and 412 provide different power supply systems. The power supply circuit 411 in the system #1 provides a power output #1, and the power supply circuit 412 in the system #2 provides a power output #2 that is different from the power output #1. The power output #1 and the power output #2 are determined according to potential levels in parts of the image forming apparatus. Note that although the example shown in FIG. 3A includes two systems, the image forming apparatus according to the present embodiment may include three or more systems.

Referring to FIG. 3B, the power supply circuit 501 includes a switch 511 and a voltage conversion circuit 512. The switch 511 controls transferring of input electric power to the voltage conversion circuit 512.

When the switch 511 is in an ON state, the power output with a voltage converted from an input power voltage is provided. On the other hand, when the switch 511 is in an OFF state, no power output is provided. The power supply control unit BC controls turning-on/off of the power supply circuit 501 such that after the control unit 109 is switched into the power saving mode, only some of or all of devices in the control unit 109 are selectively supplied with electric power to allow the NIC unit 107 to respond by proxy to a job received from the host apparatus 110. The above-described devices in the control unit 109 include the CPU 109A, the ROM 109B, and the RAM 109C. The determination as to whether electric power is supplied to only some of or all of devices in the control unit 109 is made by the CPU 121 of the NIC unit 107 according to a packet pattern of a received job and a power state specified for the packet pattern registered in advance.

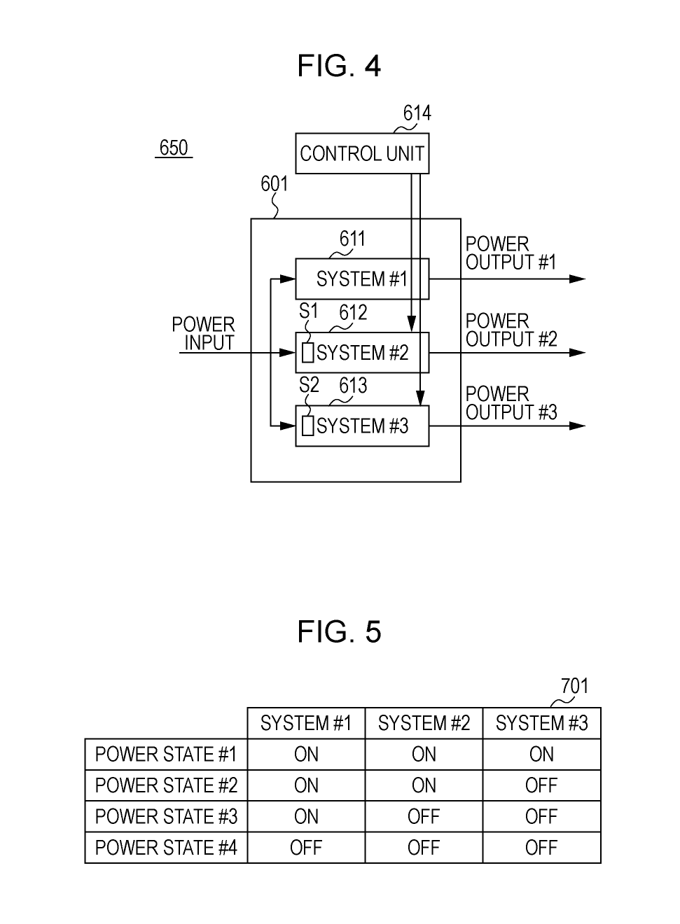

FIG. 4 illustrates a configuration of a power supply control unit including a control unit that controls the switch 511 shown in FIG. 3. In the example shown in FIG. 4, the power supply control unit 650 includes a control unit 614 and a power supply unit 601.

In FIG. 4, the power supply unit 601 includes a power supply circuit 611 corresponding to a system #1 including no switch (corresponding to the switch 511 shown in FIG. 3B) that turns on/off electric power. The power supply unit 601 also includes power supply circuits 612 and 613 corresponding to systems #2 and #3 including switches S1 and S2 that turn on/off electric power.

The power supply circuit 612 including the switch S1 and the power supply circuit 613 including the switch S2 are connected to the control unit 614 that controls turning-on/off of electric power.

The power supply circuit 612 and the power supply circuit 613 each can be in either the ON state or OFF state under the control of the control unit 614. The power supply unit 601 as a whole has three power states. Note that the control unit 614 is disposed in the power supply control unit BC.

If a special power state in which all power supply circuits 611, 612, and 613 are in the OFF state is also counted, the power supply unit 601 has a total of four power states as shown in FIG. 5.

Note that FIG. 5 illustrates an example of a state table indicating power states of the power supply circuit shown in FIG. 4. That is, FIG. 5 illustrates power states #1 to #4 in which each system is in the ON or OFF state. Note that the power state #4 is special in that all systems #1 to #3 are in the OFF state. The system #1 corresponds to the power supply circuit 611 having no switch, and thus the system #1 can be only in the ON state for all power states #1 to #3 except for the special power state #4.

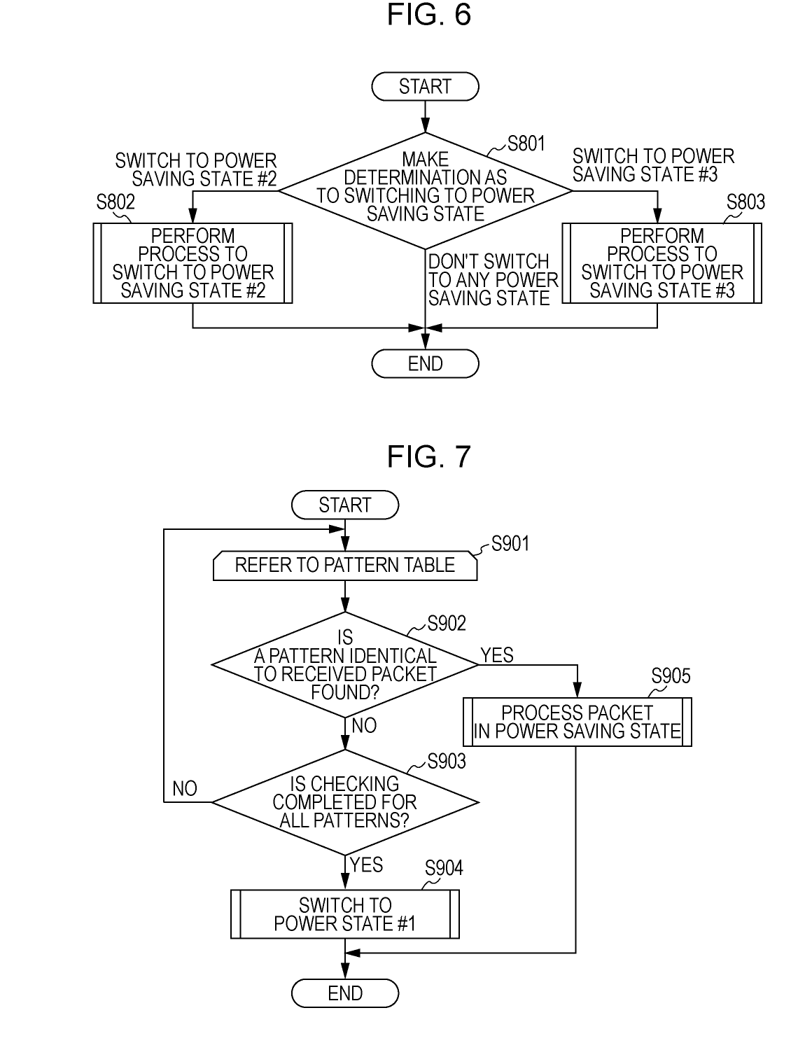

FIG. 6 is a flow chart illustrating an example of a power control procedure performed in the image forming apparatus according to the present embodiment of the invention. That is, FIG. 6 illustrates a process of periodically determining whether the power state is allowed to be switched into a power saving state. Depending on the determination, the power state is switched into the power state #2 or #3 or other power states. In FIG. 6, the process includes steps S801 to S803 that are performed by the CPU 109A in the control unit 109 shown in FIG. 1.

In step S801, the CPU 109A of the control unit 109 determines whether the image forming apparatus is allowed to be switched into a power saving state. If switching into a power saving state is allowed, then a further determination is made as to which power saving state to switch to.

For example, in a case where the reader unit 103 is in operation of reading a document or in a case where the printer unit 104 is in operation of printing, the CPU 109A of the control unit 109 determines that switching into a power saving state is not allowed. Even in a case where switching into a power saving state is allowed, if switching into the power saving state #3 is prohibited by a user, the CPU 109A of the control unit 109 determines that switching into the power saving state #2 is to be performed.

If the determination in step S801 by the CPU 109A of the control unit 109 is that switching into a power saving state is not to be performed, the process is ended.

On the other hand, in a case where the determination in step S801 by the CPU 109A of the control unit 109 is that switching into the power saving state #2 shown in FIG. 5 is to be performed, the process proceeds to step S802 to perform switching into the power saving state #2. After switching into the power saving state #2 is completed, the process is ended. In the process of switching into the power saving state #2, the CPU 109A of the control unit 109 sends a command to the control unit 614 to switch the power state into the power state #2. In response, the control unit 614 turns off the power to the power supply circuit 613.

In a case where the determination in step S801 by the CPU 109A of the control unit 109 is that switching into the power saving state #3 is to be performed, the process proceeds to step S803 to perform switching into the power saving state #3.

In the process of switching into the power saving state #3, the CPU 109A of the control unit 109 sends a command to the control unit 614 to switch the power state into the power state #3. In response, the control unit 614 turns off the power to the power supply circuit 612 and the power supply circuit 613.

In the manner described above, the power state of the image forming apparatus 100 is controlled.

FIG. 7 is a flow chart illustrating an example of a power control procedure performed in the image forming apparatus according to the present embodiment of the invention. This process is performed when the NIC unit 7 receives a network packet in a situation in which the image forming apparatus 100 is in the power state #3. In FIG. 7, the process includes steps S901 to S905 that are performed by the CPU 121 in the NIC unit 107.

In step S901, the CPU 121 in the NIC unit 107 refers to a pattern table that will be described later. Next, in step S902, the CPU 121 in the NIC unit 107 determines whether a pattern of a received network packet is equal to one of registered packet patterns.

More specifically, in step S902, the CPU 121 in the NIC unit 107 compares the packet received via the network with pattern data in the pattern table to determine whether the pattern of the received packet is identical to one of registered patterns. In a case where the CPU 121 in the NIC unit 107 determines that there is no identical pattern, the process proceeds to step S903. Note that the patterns subjected to the comparison are registered in advance in the packet pattern database 127 shown in FIG. 2.

In step S903, the CPU 121 in the NIC unit 107 determines whether the comparison is completed for all patterns in the pattern table. In a case where it is determined that the comparison is competed for all patterns in the pattern table, the process proceeds to step S904, but otherwise the process returns to step S901 to determine whether the network pattern is identical to a next pattern in the pattern table.

In step S904, the CPU 121 in the NIC unit 107 switches the power state into the power state #1 shown in FIG. 5 and performs a normal process on the received packet. After step S904 is completed, the process is ended. This case can occur when the received packet cannot be dealt with only by the NIC unit 7. A specific example is a case in which the received job includes print data to be printed.

On the other hand, in a case where it is determined in step S902 by the CPU 121 in the NIC unit 107 that the received network packet is identical to one of patterns in the pattern table, the process proceeds to step S905.

In step S905, the CPU 121 in the NIC unit 107 deals with the packet received via the network in a power saving state. After step S905 is completed, the process is ended. The process in step S905 will be described in further detail later.

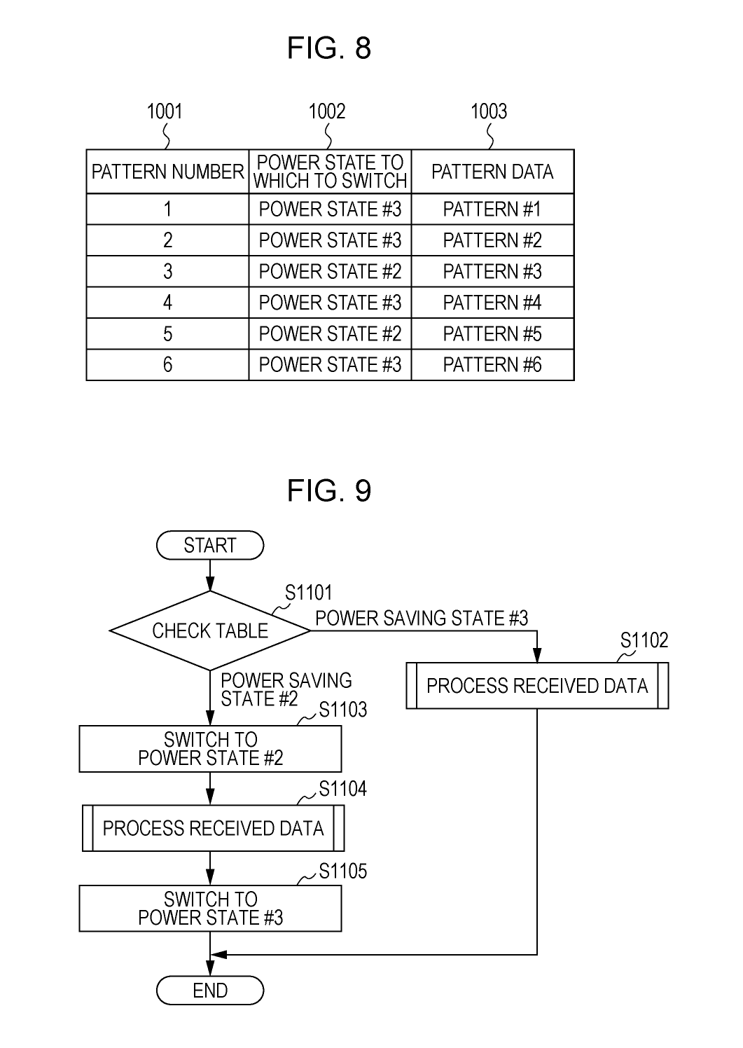

FIG. 8 illustrates an example of a pattern table managed by the NIC unit 107 shown in FIG. 1. More specifically, this example of the pattern table shown in FIG. 8 is used in step S902 shown in FIG. 7 by the CPU 121 in the NIC unit 107 to determine whether the network packet received via the network is identical to one of patterns described in the pattern table. Note that this pattern table is stored in advance in the packet pattern database 127 shown in FIG. 2.

In the pattern table shown in FIG. 8, pattern data 1003 with which to compare a received network packet is described in relation to a target power state 1002 to which to switch if the received network packet is identical to pattern data. In the example shown in FIG. 8, there are six target power states. The pattern table makes it possible to select one of power states corresponding to respective power saving states.

For example, when an echo request of ICMP (Internet Control Message Protocol) is received, a predetermined response is returned. Because the response is predetermined, the NIC unit 107 can respond to the echo request without changing the power state.

In this case, an ICMP echo request is described as a pattern in the pattern data 1003 and a power state #3 is described as a target power state 1002 corresponding to the ICMP echo request.

In the case of SNMP (Simple Network Management Protocol), it has an interface to inquire what internal state the apparatus is in. Note that the apparatus does not necessary remain in the same internal state but can switch into a different internal state.

In a case where when the response varies depending on which internal state the apparatus is in, the power state is returned into the normal state for the whole image forming apparatus 100 including the control unit 109, and status information is acquired. In accordance with the acquired status information, the response is performed.

In this case, various inquiry packet patterns of SNMP are described as patterns in the pattern data 1003, and the power state #2 is described as a target power state 1002 assigned to the those patterns.

FIG. 9 is a flow chart illustrating an example of a power control procedure performed in the image forming apparatus according to the present embodiment of the invention. More specifically, FIG. 9 illustrates the details of step S905 that is performed when it is determined in step S902 that a pattern identical to a received network packet is found in the pattern table. In FIG. 9, the process includes steps S1101 to S1105 that are performed by the CPU 121 in the NIC unit 107.

First, in step S1101, the CPU 121 in the NIC unit 107 determines based on the pattern table whether the power saving state #3 is specified as the target power state to which to switch. More specifically, the CPU 121 in the NIC unit 107 refers to data described in the column “target power state” 1002 of the pattern table shown in FIG. 8 and determines the target power state to which to switch.

In a case where the determination by the CPU 121 in the NIC unit 107 is that the power state #3 is the target power state to which to switch, switching is not necessary because the process is being currently performed in the power state #3. In this case, the process proceeds to step S1102.

In step S1102, the NIC unit 107 performs a predetermined process. For example, an ICMP echo reply is returned in response to an ICMP Echo Request. After step S1102, the process is ended. Thus, in this case, the power saving state of the control unit 109 is maintained.

On the other hand, in a case where the determination in step S1101 by the CPU 121 in the NIC unit 107 is that the power state #2 is the target power state to which to switch, the process proceeds to step S1103. In step S1103, under the control of the CPU 121 of the NIC unit 107, the power supply control unit BC switches the power state.

More specifically, the CPU 121 in the NIC unit 107 sends a command to the control unit 614 shown in FIG. 5 to switch the power state into the power state #2. In response, the control unit 614 turns on the power to the power supply circuit 612 corresponding to the system #2.

In step S1103, after the power supply circuit 612 corresponding to the system #2 is turned on, the CPU 121 in the NIC unit 107 acquires data from a location (for example, a memory in the control unit 109) that has been turned on into an accessible state, and performs a response process. This case occurs, for example, when the NIC unit 107 responds differently depending on a received inquiry such as an SNMP inquiry.

After the response process by the NIC unit 107 is completed, the processing flow proceeds to step S1104. In step S1104, the CPU 121 in the NIC unit 107 returns the power state of the power supply circuit 612 into the power state #3. Thereafter, the process is ended.

As a result, the electric power in the systems #2 and #3 are turned off into the OFF state. Thus, the system #2 is in the ON state only for a minimum necessary period, and the system #2 is returned into the previous power state at the end of the minimum necessary period.

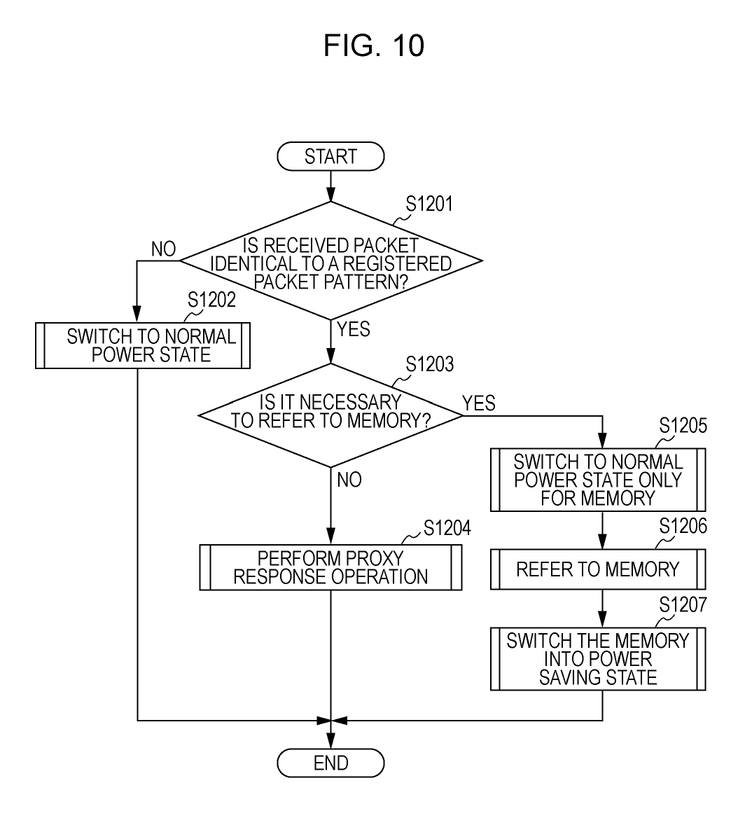

FIG. 10 is a flow chart illustrating an example of a power control procedure performed in the image forming apparatus according to the present embodiment of the invention. More specifically, FIG. 10 illustrates an example of a proxy response process performed by the NIC unit 107. In FIG. 10, the process includes steps S1201 to S1207 that are performed by the CPU 121 in the NIC control unit 124 by loading a control program from a ROM 122 to a RAM 123 and executing it. More specifically, in this process, the CPU 121 of the NIC unit 107 reads information stored in the RAM 109C in the control unit 109 and responds to a received job by proxy.

The RAM 109C of the control unit 109 is realized using a DRAM, and the RAM 109C can be in one of switchable power states: a non-powered state; a power state in which the RAM 109C is self-refreshed and it is not allowed to read information from the RAM 109C; and a normal power state in which the RAM 109C is operable in a normal manner. The RAM 109C is controlled such that self-refreshing in a power saving state does not cause information to be lost. In an operation mode (self-refresh mode) in which self-refreshing is performed, the RAM 109C is in a power state in which the RAM 109C is supplied with a lower power supply voltage than that in the normal state. Therefore, to make it possible for the CPU 121 of the NIC unit 107 to read information from the RAM 109C, the power supply voltage level supplied to the RAM 109C is increased to a normal level. After reading of information from the RAM 109C by the CPU 121 of the NIC unit 107 is completed, the power supply voltage is returned to the voltage optimum for the self-refreshing operation (steps S1205 to S1207).

First, in step S1201, the CPU 121 of the NIC unit 107 determines whether a received packet is identical to a packet registered in the packet pattern database 127. In a case where the CPU 121 in the NIC unit 107 determines that the packet is not registered, the process proceeds to step S1202 to awake the control unit 109 from the sleep and transfer the packet to the control unit 109. In step S1202, under the control of the CPU 121, the power supply control unit BC returns the power state into the power state #1. After step S1202 is completed, the process is ended. Thereafter, the received packet is transferred from the NIC unit 171 to the control unit 109, and a response process is performed for the packet.

On the other hand, in a case where the determination in step S1201 by the CPU 121 is that the packet received by the NIC unit 107 is identical to a packet registered in the packet pattern database 127, the process proceeds to step S1203.

In step S1203, the CPU 121 determines whether, to deal with the received packet, it is necessary to access the memory in the control unit 109 that is in the power saving mode. In a case where the CPU 121 determines that it is not necessary to access the memory in the control unit 109 but it is possible to respond to the packet by accessing the memory in the NIC unit 107, the process proceeds to step S1204.

In step S1204, the CPU 121 performs the proxy response process described above with reference to FIG. 9. After step S1204 is completed, the process is ended.

On the other hand, in a case where the CPU 121 determines in step S1203 that it is not possible to respond to the packet by only accessing the memory in the NIC unit 107 without accessing the memory in the control unit 109, the process proceeds to step S1205.

In step S1205, under the control of the CPU 121, the power supply control unit BC re-activates only the RAM 109C in the control unit 109. In step S1206, the CPU 121 accesses the RAM 109C in the control unit 109 to acquire information necessary in the response process. Next, in step S1207, under the control of the CPU 121, the power supply control unit BC switches the power state into the power saving state by again turning off the electric power to the RAM 109C in the control unit 109. After step S1207 is completed, the process is ended.

Thus, depending on the content of the inquiry, the control unit 109 is maintained in the power saving state or is switched to another particular-level power saving state or fully switched into the normal power state. Thus, when the NIC unit 107 receives a packet, even if proxy response by the NIC unit 107 is not allowed for this received packet, it is not necessary to return the power state into the normal power state for all devices in the control unit 109, but it is sufficient to supply electric power to, for example, the memory necessary in responding to the packet. That is, the reactivation is performed only for particular devices. The devices include memory resources such as the memory or the hard disk disposed in the control unit 109.

In the embodiments described above, it is assumed that the image forming apparatus is an electrophotographic image forming apparatus. However, the present invention is also applicable to other types of image forming apparatuses such as an ink-jet image forming apparatus.

The image forming apparatus is not limited to the MFP (Multi Function Peripheral), but the image forming apparatus may be a single-function apparatus such as a printer.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-221340, filed Sep. 25, 2009, which is hereby incorporated by reference herein in its entirety.

What is claimed is:

1. An information processing apparatus comprising a processing unit configured to process data and a storage unit configured to store data, the information processing apparatus being operable in one of power states including a first power state in which the processing unit can process data and can read data from the storage unit, a second power state in which the processing unit cannot process data but the processing unit can read data from the storage unit, and a third power state in which the processing unit cannot process data and the processing unit cannot read data from the storage unit, the information processing apparatus further comprising:
a receiving unit configured to receive data; and
a control unit configured to control the power state of the information processing apparatus such that in a case where the receiving unit receives data when the information processing apparatus is operating in the third power state, the power state of the information processing apparatus is controlled as follows: in a case where the data received by the receiving unit does not need a process by the processing unit but data stored in the storage unit is necessary in processing the data received by the receiving unit, the power state of the information processing apparatus is switched from the third power state into the second power state; and in a case where the data received by the receiving unit does not need a process by the processing unit and data stored in the storage unit is not necessary in processing the data received by the receiving unit, the power state of the information processing apparatus is maintained in the third power state.

2. The information processing apparatus according to claim 1, wherein a control unit control the power state of the information processing apparatus such that, in a case where the data received by the receiving unit needs a process by the processing unit, the power state of the information processing apparatus is switched from the third power state into the first power state.

3. The information processing apparatus according to claim 1, wherein in a case where the control unit switches the power state of the information processing apparatus from the third power state into the first power state, the processing unit processes the data received by the receiving unit.

4. The information processing apparatus according to claim 1, wherein in a case where the control unit switches the power state of the information processing apparatus from the third power state into the second power state, the processing unit processes the data received by the receiving unit.

5. The information processing apparatus according to claim 1, wherein in a case where the control unit maintains the power state of the information processing apparatus in the third power state, the processing unit processes the data received by the receiving unit.

6. The information processing apparatus according to claim 1, wherein when the information processing apparatus is in the third power state, the control unit is capable of processing data.

7. A method of controlling an information processing apparatus including a processing unit configured to process data and a storage unit configured to store data, the information processing apparatus being operable in one of power states including a first power state in which the processing unit can process data and can read data from the storage unit, a second power state in which the processing unit cannot process data but the processing unit can read data from the storage unit, a third power state in which the processing unit cannot process data and the processing unit cannot read data from the storage unit, the method comprising:
receiving data; and
controlling the power state of the information processing apparatus such that in a case where data is received when the information processing apparatus is operating in the third power state, the power state of the information processing apparatus is controlled as follows: in a case where the received data does not need a process by the processing unit but data stored in the storage unit is necessary in processing the received data, the power state of the information processing apparatus is switched from the third power state into the second power state; and in a case where the received data does not need a process by the processing unit and data stored in the storage unit is not necessary in processing the received data, the power state of the information processing apparatus is maintained in the third power state.

8. A computer-readable storage medium including a computer-executable program for controlling an information processing apparatus including a processing unit configured to process data and a storage unit configured to store data, a first power state in which the processing unit can process data and can read data from the storage unit, a second power state in which the processing unit cannot process data but the processing unit can read data from the storage unit, a third power state in which the processing unit cannot process data and the processing unit cannot read data from the storage unit, the computer-executable program comprising:
receiving data; and
controlling the power state of the information processing apparatus such that in a case where data is received when the information processing apparatus is operating in the third power state, the power state of the information processing apparatus is controlled as follows: in a case where the received data does not need a process by the processing unit but data stored in the storage unit is necessary in processing the received data, the power state of the information processing apparatus is switched from the third power state into the second power state; and in a case where the received data does not need a process by the processing unit and data stored in the storage unit is not necessary in processing the received data, the power state of the information processing apparatus is maintained in the third power state.
